(19) United States
(12) Patent Application Publication
(10) Pub. No.: US 2010/0191708 A1
(43) Pub. Date: Jul. 29, 2010

(54) Synchronous Deletion of Managed Files

(75) Inventors: Carsten Brixius, Niedermoschel (DE); Wayne C. Hineman, San Jose, CA (US); Christian Mueller, Dichtelbach (DE); Douglas S. Noddings, Export, PA (US); Wayne A. Sawdon, San Jose, CA (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/358,494

(22) Filed: Jan. 23, 2009

(51) Int. Cl. G06F 12/02; G06F 17/30; G06F 9/46

(52) U.S. Cl. 707/662; 718/100; 707/E17.01

(57) ABSTRACT

A method of synchronous deletion of managed files in a file system includes receiving a destroy event for a file to be deleted from the file system, the destroy event being generated upon request to destroy a file or corresponding objects of the files system; processing the received destroy event. Processing the destroy event includes determining if hierarchical storage management of the file system is initiated, and if initiated, continuing processing of the received destroy event; blocking threads indefinitely for an event storm during processing of the received destroy event; determining if the file to be deleted is being premigrated, migrated or is being recalled; aborting migration of the file based on the determination of migration and recall; and deleting the file and server objects corresponding to the file from the file system, where initiation of file deletion and server object deletion are synchronous.

### BACKGROUND

1. Technical Field

This invention generally relates to deletion of managed files. More particularly, this invention relates synchronous deletion of Hierarchical Storage Management managed files.

2. Description of Background

Generally, an archive manager appliance is an integrated solution including both a General Parallel File System (GPFS) and a storage management space manager (i.e., Hierarchical Storage Management (HSM)). The HSM client manages secondary storage for an archive manager and provides a means by which data may be transparently migrated and recalled within the archive manager storage hierarchy. An archive manager may be a high-end storage appliance enabling the information life cycle management of stored contents. Hence, very high performance characteristics as well as rapid content deletion when requested are fundamental to archive managers. HSM managed files have corresponding objects stored on storage manager servers which must be deleted when HSM stub files are deleted.

Thus, an archive manager must be able to process high volumes of file deletions, and process them such that server objects corresponding to HSM managed files are deleted when the files are deleted.

Conventionally, HSM employs a completely asynchronous reconciliation process which performs a cleanup of server space where corresponding file stubs have been deleted. This is a resource intensive process which does not scale well for very large numbers of files. Further, server objects corresponding to HSM managed files which have been deleted will linger until the reconcile process is performed, which can be days or weeks after the file(s) have been removed.

### BRIEF SUMMARY

According to an example embodiment, a method of synchronous deletion of managed files in a file system includes receiving a destroy event for a file to be deleted from the file system, the destroy event being generated upon request to destroy a file for corresponding objects of the files system; processing the received destroy event. Processing the destroy event includes determining if hierarchical storage management of the file system is initiated, and if initiated, continuing processing of the received destroy event; blocking threads indefinitely for an event storm during processing of the received destroy event; determining if the file to be deleted is being migrated or is being recalled; aborting migration of the file based on the determination of migration and recall; and deleting the file and server objects corresponding to the file from the file system, where initiation of file deletion and server object deletion are synchronous.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a method of synchronous deletion of managed files, according to an example embodiment;

FIG. 2 illustrates a computer apparatus, according to an example embodiment.

The detailed description explains an exemplary embodiment, together with advantages and features, by way of example with reference to the drawings.

### DETAILED DESCRIPTION

According to an exemplary embodiment, a system and methodology are provided which significantly decrease the complexity of deleting HSM managed files. This decrease in complexity enables better overall performance as no reconciliation is required during deletion, and enable archive manager solutions to better provide compliance to regulatory targets.

Example embodiments of the present invention provide new synchronous deletion features for HSM clients. This is enabled by a deviation to the X Open Data Storage Management API Specification. The specification documents an asynchronous file delete event. This design provides a synchronous file delete event. The general parallel file system (GPFS) provides for enabling this synchronous event on a mounted file system, and the HSM client processes these events, synchronously initiating deletion of corresponding server objects.

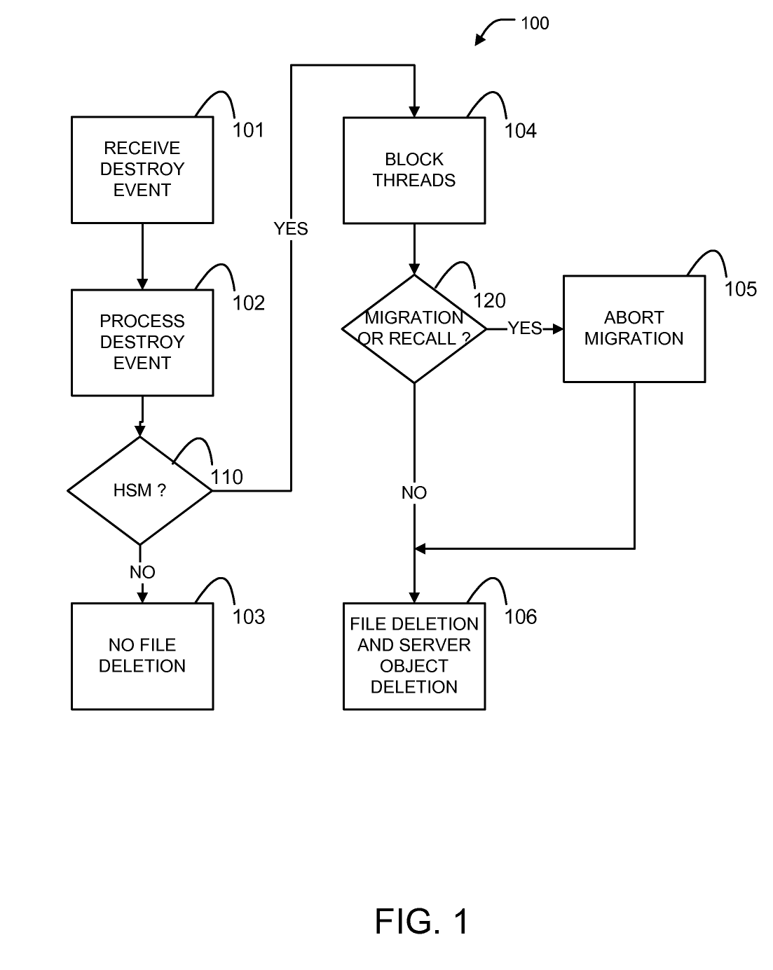

Turning to FIG. 1, a method of synchronous deletion of managed files is illustrated. According to FIG. 1, the method 100 includes receiving a destroy event at block 101 and processing the destroy event at block 102.

A destroy event is defined as an asynchronous metadata event. This event is generated when an Operating System has destroyed an object. Because the destroy event will be handled synchronously according to example embodiments, queue overflow problems within HSM are avoided. Hence, it is necessary to deviate from the X Open standard, and synchronize events through the GPFS.

Destroy events are received for all destroyed objects (e.g., files, directories, etc) in the file system. HSM processing of destroy events encompasses server object deletion both when the file is migrated and when the file is pre-migrated.

However, if a file system is data management API (DMAPI) enabled, GPFS will not mount the file system until a data management session registers for the mount event, receives the mount event, and replies to it. According to the DMAPI standard it is not possible to set any file system, or data event, before a mount is completed.

The method 100 further includes determining if HSM is initiated at block 110. If there is not an HSM client running/initiated, the method 100 includes aborting the file deletion at block 103. If there is a HSM running/initiated, the method 100 includes blocking threads at block 104.

For example, it is assumed that, according to an example implementation, GPFS will not lose destroy events even in overflow scenarios, for example, if destroy storms occur (e.g., “rm—rf/filesystem” commands) but rather block file deletion until sufficient DMAPI resources are available for the destroy event to be successfully handled by the HSM.

Synchronous events block a thread and the state for the event is kept on thread's stack, allowing the event to be retried if DMAPI queue is overrun. Normally for synchronous events a thread will block until some configurable timeout is reached, and if a timeout occurs the thread fails the original user request. However, according to example embodiments, threads are blocked indefinitely in an event storm scenario as there is no user request pending that can fail. The number of concurrent operations is limited by the number of threads. If all threads are in-use (or are waiting for the data management server) then no new work is started. Each synchronous destroy event consumes a thread which serves to throttle the file system under heavy load.

The method 100 further includes determining if a file is being premigrated, migrated or recalled at block 120. It is conceivable that a destroy event will arrive while a file is being premigrate, migrated or while it is being recalled. In the migrating case (block 105), the file migration is aborted, and the data migrated to date is automatically removed by the server in regular transaction processing. With an archive manager solution, it is expected that there will be no HSM scout daemon running, so there is no need to delete the file from any scout auto-migration candidate list.

If a file is being recalled (i.e., regular, streaming, or partial mode), the next file operation is expected to fail and the initial data event will subsequently be aborted. It is noted that exclusive access rights to a file are not necessarily always held by HSM during a recall to enable streaming for instance.

The method further includes file deletion and server object deletion at block 106. Server object deletion is initiated synchronously to file deletion, though handled asynchronously in that an object verb will be sent to the server to delete the object corresponding to file, but destroy processing will proceed asynchronously to the result of the server object deletion.

Therefore, as described above, example embodiments include new synchronous deletion features for HSM clients and a method of synchronous deletion of HSM managed files. The method includes receiving and processing a destroy event, blocking threads of event storms, aborting migrations based on file status, and synchronous file and server object deletion.

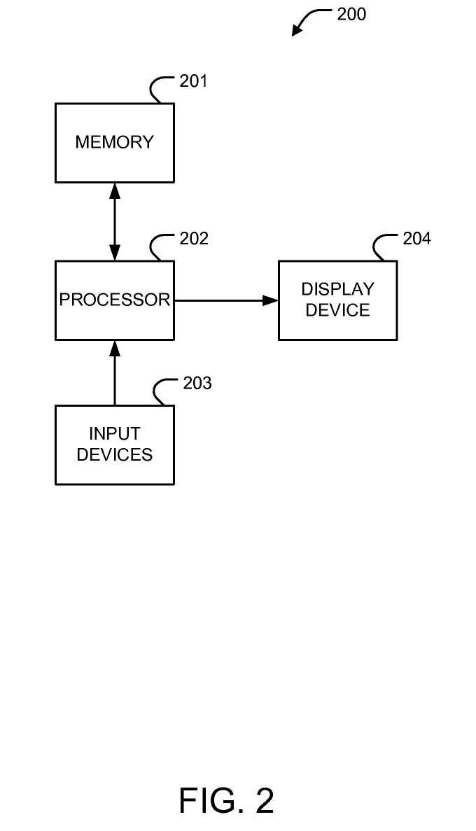

Furthermore, according to an exemplary embodiment, the methodologies described hereinbefore may be implemented by a computer system or computer gaming apparatus. Therefore, portions or the entirety of the methodologies described herein may be executed as instructions in a processor of the computer system. The computer system includes memory for storage of instructions and information, input device(s) (e.g., see FIG. 2) for computer communication, and display devices. Thus, the present invention may be implemented, in software, for example, as any suitable computer program on a computer system somewhat similar to the computer systems described above. For example, a program in accordance with the present invention may be a computer program product causing a computer to execute the example methods described herein.

The computer program product may include a computer-readable medium having computer program logic or code portions embodied thereon for enabling a processor (e.g., 202) of a computer apparatus (e.g., 200) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

With an exemplary embodiment of the present invention having thus been described, it will be obvious that the same may be varied in many ways. The description of the invention hereinbefore uses this example, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Such variations are not to be regarded as a departure from the spirit and scope of the present invention, and all such modifications are intended to be included within the scope of the present invention as stated in the following claims.

1. A method of synchronous deletion of managed files in a file system, comprising:
receiving a destroy event for a file to be deleted from the file system, the destroy event being generated upon request to destroy a file or corresponding objects of the files system;
processing the received destroy event, wherein processing includes:
determining if hierarchical storage management of the file system is initiated, and if initiated, continuing processing of the received destroy event;
blocking threads indefinitely for an event storm during processing of the received destroy event;
determining if the file to be deleted is being premigrated, migrated or is being recalled;
aborting migration of the file based on the determination of migration and recall; and
deleting the file and server objects corresponding to the file from the file system, where initiation of file deletion and server object deletion are synchronous.

2. The method of claim 1, wherein the file system is a general parallel file system (GPFS) and the GPFS is data management API (DMAPI) enabled.

3. The method of claim 1, wherein the destroy event is an asynchronous metadata event generated as an Operating System destroys or requests the destruction of an object.
